(19) United States
(12) Patent Application Publication
(10) Pub. No.: US 2007/0219001 A1
(43) Pub. Date: Sep. 20, 2007

(54) Method and System for Karma Accumulation, Death and Post-Death Gameplay in a Virtual Environment

(75) Inventors: Raymond J. Mueller, Palm Beach Gardens, FL (US); Andrew S. Van Luchene, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/735,082

(22) Filed: Apr. 13, 2007

Related U.S. Application Data
(63) Continuation-in-part of application No. 11/621,886, filed on Jan. 10, 2007.
(63) Continuation-in-part of application No. 11/368,143, filed on Mar. 3, 2006.
(60) Provisional application No. 60/727,121, filed on Oct. 14, 2005.

(51) Int. Cl. A63F 13/00

(52) U.S. Cl. 463/43

(57) ABSTRACT

A method and system are provided to allow karma accumulation, death and post-death gameplay in a virtual environment. In post-death gameplay, at least one character attribute is used to determine whether a player character can play an undead character, possess a selected player character, and/or reincarnate into a new player character. The method of karma accumulation includes tracking positive karma points and negative karma points.

### PRIORITY CLAIM

The following application claims priority to U.S. patent application Ser. No. 11/621,886, “Video Game with Reverse Outcome Game Attributes” filed Jan. 10, 2007, and Ser. No. 11/368,143, “Video Game Methods and Systems” filed Mar. 3, 2006, which claims the benefit of U.S. Provisional Patent Application No. 0/727,121 “Methods, Processes and Systems to Enhance a Player Experience of a Video Game” filed Oct. 14, 2005, each of which is hereby incorporated by reference.

### BACKGROUND

Virtual Environments which are accessible to multiple subscribers via a server are well known. For example, hundreds of thousands of players access games known as massive multi player online games (MMOGs). Players of these games customarily access a game repeatedly (for durations typically ranging from a few minutes to several days) over given period of time, which may be days, weeks, months or even years. The games are often constructed such that players pay a periodic subscription price (e.g., $15 per month) rather than, or in addition to, paying a one time purchase price for the game. Often, though not necessarily, these games have no ultimate “winner” or “winning goal,” but instead attempt to create an enjoyable playing environment and a strong player community. Virtual communities like Linden Lab's “Second Life” provide a three-dimensional metaverse in which people (who may or may not pay a fee for the right to access the metaverse) create avatars that are able to interact with other avatars as well as the local environment. It would be advantageous to provide improved methods and apparatus for increasing the enjoyment and/or longevity of these virtual environments.

### SUMMARY OF THE INVENTION

A method of providing gameplay in a virtual environment comprising providing a player with an ability to play a player character with character attributes; upon death of the player character, providing the player with an ability to play an undead player character with limited character attributes, the limited character attributes including a subset of the character attributes of the player character; wherein the limited character attributes include karma.

Another method of providing gameplay in a virtual environment comprising reviewing at least one character attribute of the deceased player character; determining if a deceased player character qualifies for reincarnation; and if the deceased player character qualifies for reincarnation, creating a new player character from the deceased player character.

In another aspect of providing gameplay in a virtual environment, the method includes receiving an indication that a player character desires to possess a selected player character; determining whether to allow the player character to possess the selected player character, wherein determining is, at least in part, based on at least one character attribute of the player character; allowing the player character possession of the selected player character; and determining a length of time that possession is allowed.

### BRIEF DESCRIPTION OF THE DRAWINGS

FIG. 1 is a schematic diagram of a wide area network in which a virtual environment exists in one embodiment of the invention.

FIG. 2 is a schematic diagram of a wide area network in which a virtual environment exists in another embodiment of the invention.

FIG. 3 is a schematic diagram of one embodiment of a post-death module in communication with a plurality of databases.

FIG. 4 is a flowchart illustrating one embodiment of a method for gameplay allowing gameplay as an undead character.

FIG. 5 is a flowchart illustrating one embodiment of a method for gameplay allowing possession of another player character.

FIG. 6 is a flowchart illustrating one embodiment of a method for gameplay allowing reincarnation after a player character dies.

FIG. 7 is a flowchart illustrating another embodiment of a method for gameplay allowing reincarnation after a player character dies.

### DETAILED DESCRIPTION

In one or more embodiments, the present invention provides a virtual environment that allows for karma accumulation, possession, death, and post-death gameplay in a virtual environment.

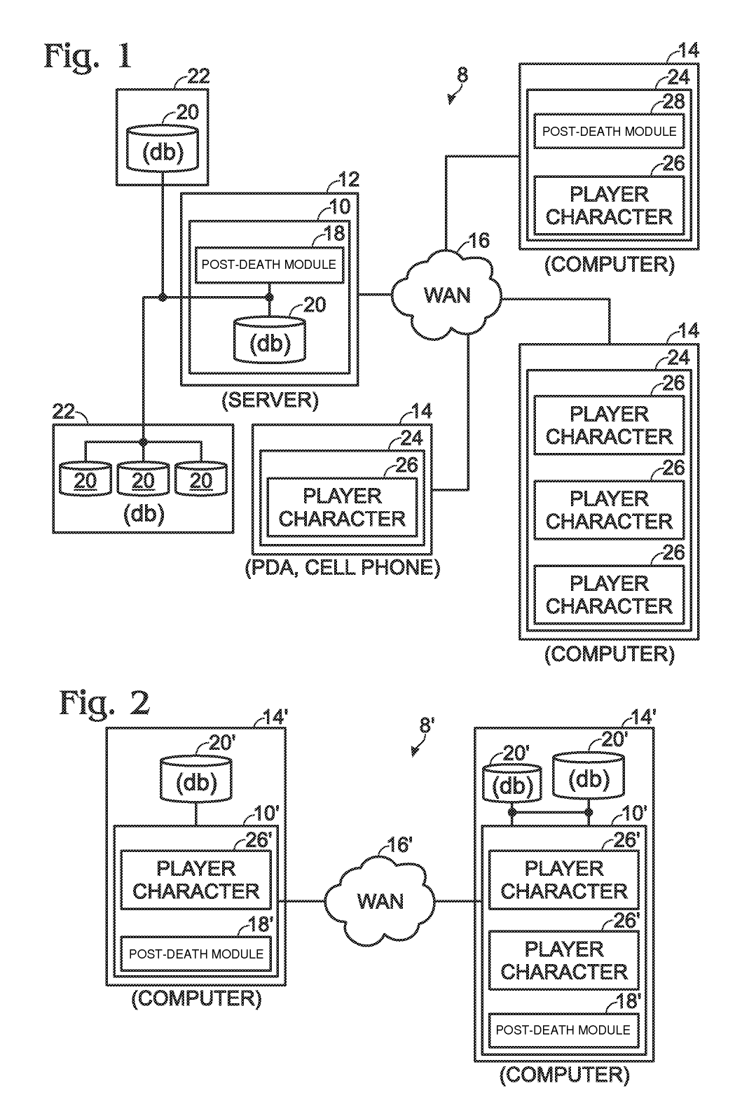

Referring to FIG. 1, a system 8 for karma accumulation, possession, death, and post-death gameplay includes a metaverse that may be created and maintained by a game program 10 residing in a video game central server 12, herein “game server”. Game program 10 may be accessed by players located at video game consoles 14 via a wide area network 16. The game program includes a post-death module 18, namely computer code allowing for karma accumulation, possession, death, and/or post-death gameplay. Post-death module 18 may retrieve and store information in various databases 20. These databases may be located locally in the game server, in external servers and/or mass storage devices 22. As used herein, a metaverse may include a collection of online virtual environments which are accessible to one or more players of one or more online games or communities. For example, Massive Multiplayer Online Role Playing Games (MMORPGs) may include a virtual game environment generated by game program 10. In this game environment (referred to herein as “game”), players may access the game at video game consoles 14 via a wide area network 16. It should be understood, that the term “game” is intended to encompass any online or virtual environment in which players may interact with each other and/or the environment via characters or avatars. Unless specifically stated, the term “game” is not intended to limit the disclosure to only those environments that are competitive in nature. Accordingly, the term game is intended to encompass virtual communities such as Linden Labs' Second Life.

Video game consoles 14 may include a local version 24 of the game program 10. The local version 24 of the game program may include local player character accounts 26 and a local post-death module 28 for access and/or communication with corresponding features in game program 10. A player located at a video game console 14 may have multiple player character accounts, each corresponding to a player character (persona) the player has created for playing the game. It should be noted that a person or entity who enters the metaverse, regardless of purpose, is considered to be “playing a game,” and therefore the person or entity is considered a “player.”

In FIG. 2, a peer-to-peer network is shown with a game program 10′ running on video game consoles 14′ in an alternate embodiment 8′ of a system for post-death gameplay. Consoles 14′ communicate via a wide area network 16′ and have the ability to access databases 20′ that may be located in each console. A post-death module 18′ is located in one or both game programs 10′, and similarly player character accounts 26′ reside in each console. Additional consoles may be connected and share information and resources accordingly.

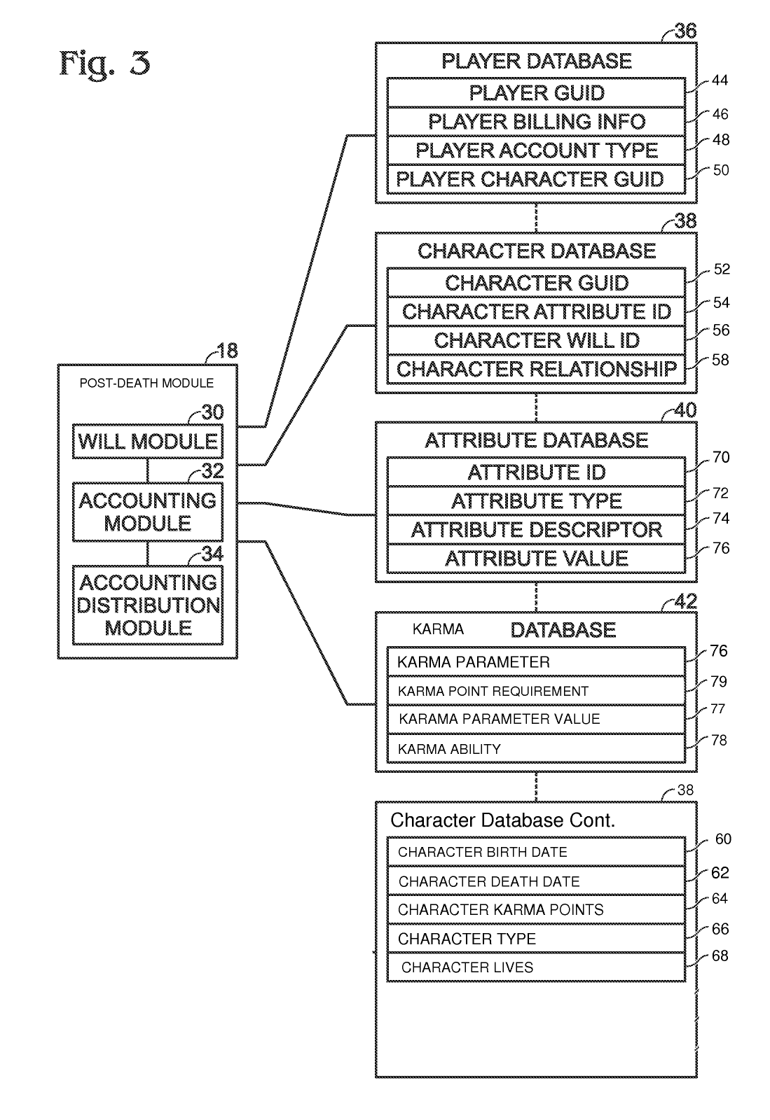

Turning to FIG. 3, in accordance with one embodiment of the invention, a schematic diagram shows a post-death module 18 including an undead character module 30, a possession module 32, and a reincarnation module 34, and further including karma accumulation. Karma is a totality of all that a player character has done. Karma does not necessarily embody the classical definition of karma in literature or religion, but instead is used as one mechanism in which to track activity in the game. Karma is herein measured in points and referred to as “karma points”, however, karma may be alternatively measured using other units, e.g., currency, credits, values, or other character attributes.

Post-death module 18 includes an undead character module for providing a player character with the ability to play an undead character, which is a once-living player character, but now dead and functioning, in some cases, with limited properties or some other deficit and/or benefit. Undead characters may be spiritual or corporeal. Examples of undead characters may include, but are not limited to: necromancers, liches, wights, mummies, vampires, wraiths, ghouls, mummies, zombies, ghosts, spirits, spectres, etc. Post-death module 18 further includes a possession module 32 for allowing a player character to possess i.e. take over the will of another player character.

Post-death module 18 further includes a reincarnation module 34 for creating a new player character from the deceased player character. Reincarnation refers to being reborn into a new player character after death. The methods and embodiments, as described below, may be implemented into the game, post-death module, and/or modules, and are not mutually exclusively used. The post-death module may require retrieving and storing of information in one or more databases, e.g., a player database 36, character database 38, attribute database 40, and karma database 42.

Player database 36 may include fields such as: player GUID 44, player billing info 46, player account type 48, and player character GUID 50. A GUID refers to a unique number for identifying a particular player, item, or other database entry. A player using GUID 44 may be identified and linked to player billing information 46. The player account type 48 may indicate the kind of gameplay that is permissible. The player may have paid an additional fee for enhanced features and should be indicated as such. For example, the player pays an extra fee to the game server or to other player characters for his player character to be able to earn karma points in a game. The player character GUID 50 identifies and associates the player character with a player account.

In character database 38, the database may include fields of character GUID 52, character attribute ID 54, character will ID 56, character relationship 58, character birth date 60, character death date 62, character karma points 64, character type 66, and character lives 68. Character relationship 58 helps to identify family members. Character birth date 60 and death date 62 indicate the lifespan. Character karma points 64 is an account of karma points earned by the player character. There may be separate accounts to track positive and negative karma points. Alternatively, the positive and negative karma points can offset each other and yield a total point count. Character type 66 may be flagged to indicate undead, possessed, or other player character. Character lives 68 indicates the number of lives lived (or still living), and is equal to the number of reincarnations −1.

The attribute database 40 may include exemplary fields such as attribute ID 70, attribute type 72, attribute descriptor 74, and attribute value 75. The attribute ID 70 is used to identify the character attribute. The attribute type 72 specifies what kind of attribute it is. For example, attribute types may be cash, food, tools, weapons, trinkets, armor, potions, spells, scrolls, quest objects, etc. The attribute descriptor 74 may be a word, phrase, or alphanumerical term to describe the attribute, an arbitrary code, or a search parameter. The attribute value 75 may be the value of the character attribute, e.g. number of karma points.

The karma database 42 may includes fields karma parameter 76, karma parameter value 77, karma ability 78, and karma point requirement 79. Karma parameter 76 is any game parameter that may result in earning positive or negative karma points. Karma parameter value 77 is the number of karma points earned. Karma ability 78 includes possession, reincarnation, or other ability that may be determined at least in part by tallying the karma points received. Karma point requirement 79 is the number of karma points that is required in order to obtain the particular karma ability.

These databases may be interdependent, i.e., if one variable changes in the database, a variable in another database may change automatically as well. Other databases and other fields within databases may be employed and are not limited to the schematics as shown in FIG. 3.

The game may impose a fixed time limit on the amount of virtual (computer-generated) or actual (in real life) time a player character can exist in a game environment. During their lifespan, player characters acquire karma points based on their activity in the game. A player's lifespan may be set to expire within a range of time that is based on the player character's race, class, nationality, gender, diet, relationships, a random number, the player character's karma points from a previous life, etc.

The player character may extend or shorten his lifespan by getting killed a certain number of times before he dies (e.g., the game may allow 3 lives before game ends), getting killed a certain number of times by a particular method before he dies (e.g., fall off mountain twice, drowning once, but ultimately dies after being shot by the police thrice), using game attributes, such as potions and armor (e.g., using the picture of Dorian Gray), purchasing or stealing life credits from another player character (e.g., buying medicine from a doctor or drinking the blood from slaves), earning karma points (e.g., accumulating positive karma points would extend his life, while negative karma points would shorten his life), and completing game parameters (i.e., any part of a game experience that may be measured or described, e.g., finding the fountain of youth). Other methods of lengthening or shortening lifespan may be utilized.

During his lifespan, the player character may establish a will that allows other player characters to which he has a relationship to receive the game attributes he has acquired over his lifespan. A will can be created by the player character or by the game server based on governing rules (e.g., as disclosed in U.S. patent application Ser. No. ______ (Attorney Docket No. 3104204) “Method and System to Allow for Inheritance Between Player Characters” filed Apr. 13, 2007, hereby incorporated by reference in its entirety). For example, a player character may specify in a will to distribute karma points to an offspring. Upon his death, if the conditions for inheritance is satisfied, the offspring will acquire karma points.

Over the course of a lifespan in the game, a player character may earn positive or negative karma points. These points may be used to affect gameplay in a number of situations. For example, karma points may be used in permitting or prohibiting action in the game. Some examples in which positive karma points (representing good karma) may be earned include: completing game parameters, killing certain other player characters, assisting other player characters to obtain attributes or complete game parameters, and having relationships with other player characters (for example, as disclosed in U.S. patent application Ser. No. 11/694,669 entitled Inter-Character Relationships in a Video Game, hereby incorporated by reference in its entirety).

Examples in which negative karma points (representing bad karma) can be gained include: failing to fulfill contracts, killing one's own offspring, having a spell cast against the player character, being killed, and having affairs or children out of wedlock.

There may be other game parameters that earn karma points. The number of karma points that can be earned may be predetermined by the game designer (as used herein, a game designer may include a person who develops the game and/or predetermines rules of gameplay), conditions, or other player characters. Karma points may vary depending on the task/condition. For example, killing one's offspring may yield −1000 karma points whereas rescuing a cat out of a tree may yield +1 karma point.

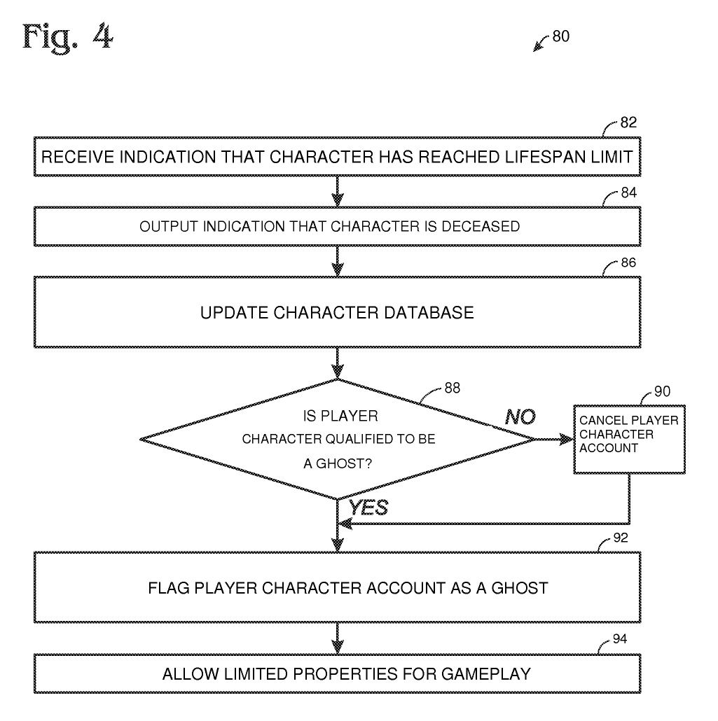

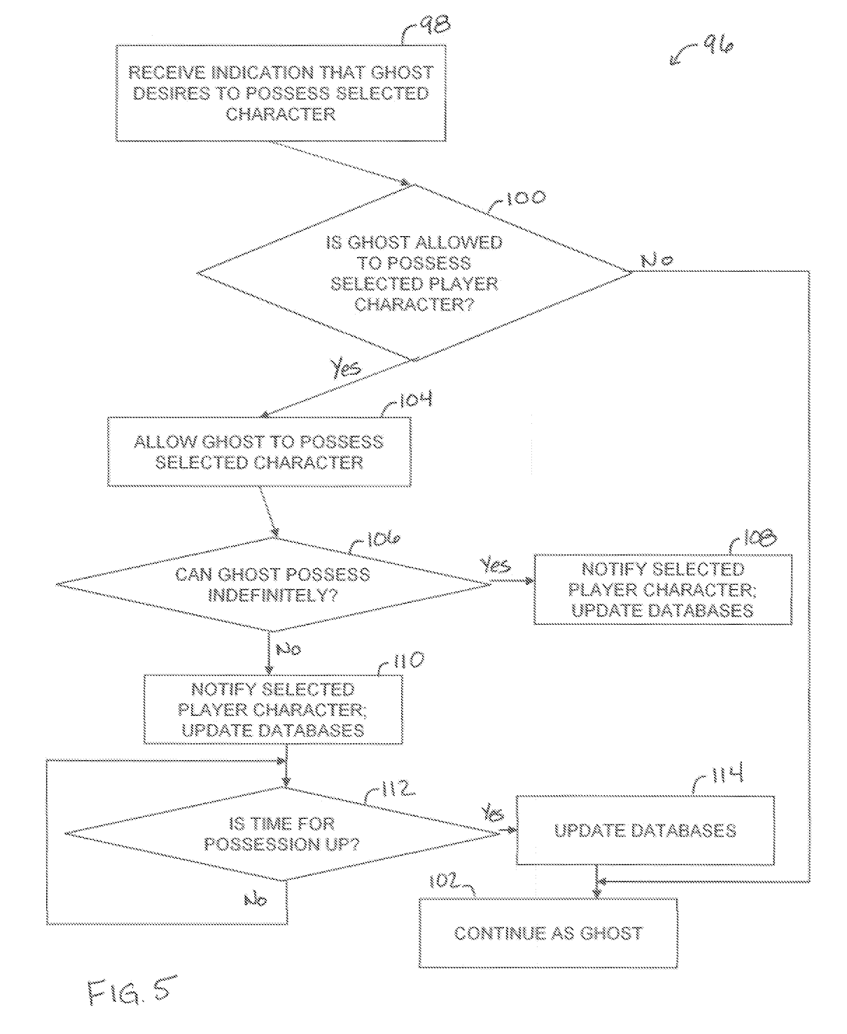

Referring to FIG. 4, a flowchart shows a method 80 for providing a deceased player character with an ability to become an undead player character. The method includes, at 82, receiving an indication that the player character has reached a lifespan time limit. The player may have died in any number of ways. At step 84, the method outputs an indication that the player character is deceased. Step 86 updates the character database. At 88, the method includes determining if the player character qualifies to be a ghost (i.e., an undead character, herein not meant to be limited to ghosts). If no, the player character does not qualify to be a ghost, the player character account is canceled at 90. If the player character qualifies to be a ghost, the method flags the player character account as ghost at step 92, and allow limited properties for gameplay at 94.

In some embodiments, when a player character dies, he may become a ghost and can play in the game environment with limited character attributes and properties. These limited properties may include, but are not limited to: the ability to communicate with or provide hints to other player characters; the ability to curse items, player characters, or places in the game; the ability to inhibit or otherwise influence the movement of certain player characters; the ability to retain specific or limited character attributes; the ability to earn positive or negative karma points by helping or hurting other player characters; and the ability to possess other player characters. The ghost's attributes and abilities are limited and includes a subset of the attributes and abilities of a player character who is alive.

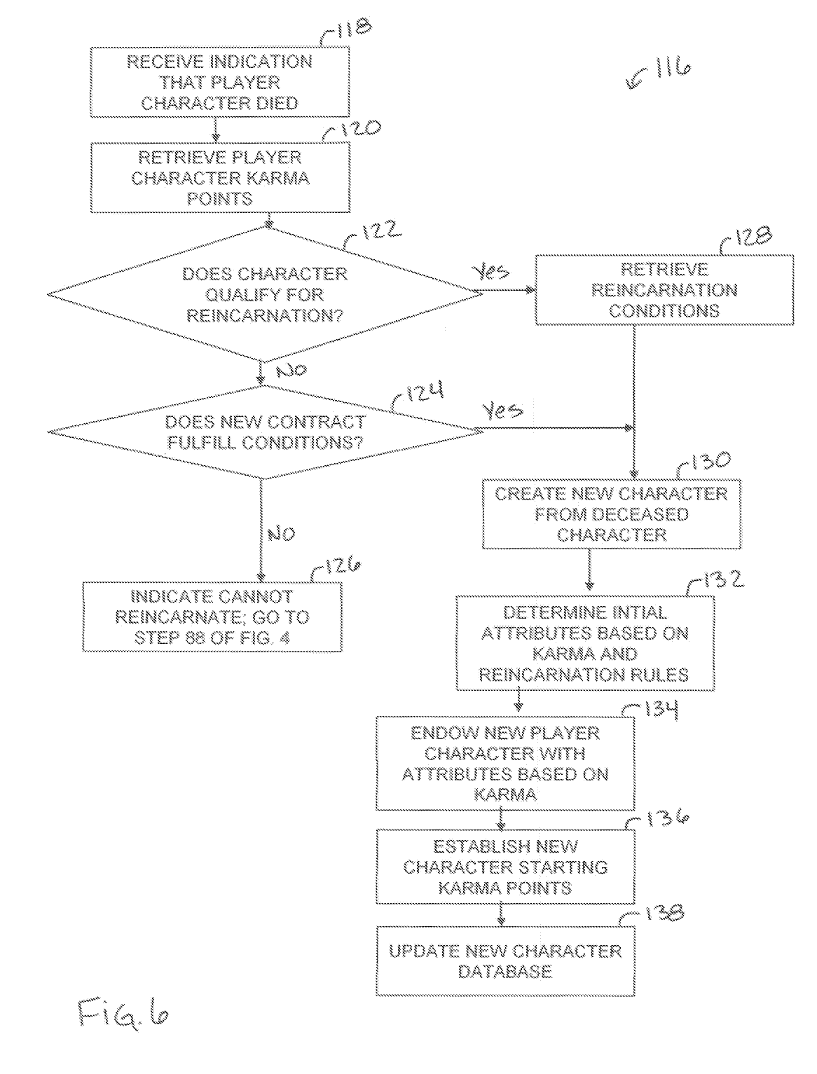

In one embodiment, when a player character becomes a ghost, he may be able to insert his will into the body of another player character. This may be one method of creating undead characters in the game. Referring to FIG. 5, a method for gameplay providing an ability to possess a selected player character is shown at 96. The method includes, at step 98, receiving an indication that a ghost desires to possess a selected player character. For example, a selection or indication may be a player moving his ghost on top of a player character and positioning a cursor over the player character's head. Method 96 includes determining if conditions are satisfied to allow a ghost to possess a selected player characters at step 100. Conditions may include a predetermined minimum number of karma points and/or other character attributes. Alternatively, conditions may include other game parameters that need to be satisfied first. Conditions may vary depending on the player character that the ghost desires to possess. For example, the player character may be a powerful player character, and therefore the ghost may need a very large number of negative karma points in order to possess the powerful player character. If the conditions are not satisfied, method 96 proceeds to 102 where the ghost continues gameplay as an undead player character.

If yes, it is determined that conditions are satisfied to allow the ghost to possess a selected player character, method 96 continues to step 104 to permit the ghost to possess the selected player character. At 106, the method includes determining whether the ghost can indefinitely possess the selected player character. Indefinite possession of another player character may be similar to reincarnation due to its lengthiness, or alternatively have its own gameplay mechanics. Even if the ghost has the ability to indefinitely possess, he may choose not to. For example, an undead player character accumulates a large number of karma points with reincarnation in mind and is getting close to reaching his goal, therefore he does not have to indefinitely possess the selected player character. If the ghost player chooses to indefinitely possess, method 96 proceeds to step 108 where the player character is notified of indefinite possession and is recorded accordingly in the databases.

If a ghost decides not to indefinitely possess the selected player character, the method advances to step 110 which includes notifying the selected player character of possession and updating the databases. The notification may provide an estimated duration of time of possession to the selected player character. The ghost character database will be flagged as possessing a player character, while the selected player character's database is flagged as being possessed. The player of the selected player character may still access the selected player character, but may have to wait until possession is over to recover control of the player character.

At step 112, in an alternate embodiment, an undead player character may possess another player character for a limited amount of time proportionate to karma points he has acquired (e.g., number of negative karma points). When time runs out, the method includes, at 114, updating databases to no longer reflect possession, and at 102, the ghost continues gameplay as a ghost.

In one embodiment, possessing a player character affords an undead player character with the opportunity and ability to accumulate karma points more quickly, as well as enjoying other gameplay aspects of the selected player character. Since playing an undead player character means playing with limited attributes and properties, by possessing another player character, there are more gameplay options.

In another embodiment, the ability to possess player characters may be available to other player characters. The ability may be subject to a certain rank, race, class, or other measurable game attribute. For example, a player character with a great number of negative karma points may be able to indefinitely possess another player character. In another embodiment, a first player character may only possess a second player character when the first player character is a ghost and the second player character has become enchanted by an undead player character in the game.

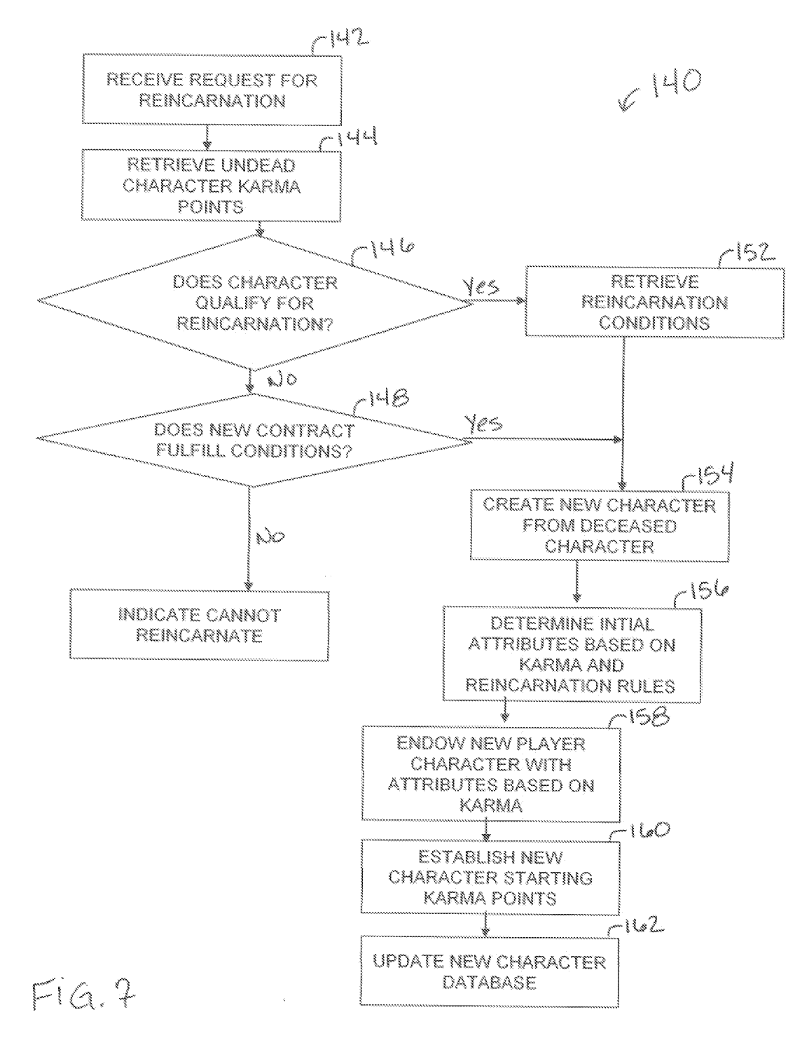

Referring now to FIG. 6, a method for gameplay providing an ability to reincarnate after a player character's death is shown at 116. In order to reinsert a player character into the game, method 116 includes, at 118, receiving an indication that a player character is deceased, and at 120, retrieving player character's karma points. Alternatively, the method may retrieve other character attributes if they are factors in reincarnation. At 122, a determination is made regarding if player character qualifies for reincarnation. Generally, karma points are reviewed and the criteria to meet may include achieving a minimum of positive karma points and not exceeding a maximum of negative karma points. If no, the player character does not qualify for reincarnation, method 116 determines if there is a new relationship contract and/or if the new relationship contract fulfills conditions at step 124. If no, indicate that there deceased player character cannot be reincarnated. The method may go to step 88 of FIG. 4 to determine if the player character qualifies to be a ghost instead.

Returning to step 122, if yes, the player character qualifies, method 116 further includes, at 128, retrieving reincarnation conditions, which may include requirements for the creation of a new player character and/or process for reincarnation. For example, conditions may involve race, class, family, etc. The method then proceeds to step 130.

At step 124, a new relationship contract is determined to fulfill reincarnation conditions. As an example, the player character develops a new player contract that allows him to be reinserted into the game as a child of one or more of the members of his family. Once two player characters are able to have children, the player character can be removed from the game as a ghost and reinserted as a new player character that is the child of the other two player characters. The method includes, at step 130, creating a new player character from the deceased player character.

At step 132, the method includes determining initial character attributes based on karma and reincarnation rules. For example, when the player character is reinserted in the game, his karma points may establish: the character attributes he begins with in the game (e.g. a player character with good karma could start the game with a really good weapon); his new player character lifespan (i.e. a player character with good karma could be given an extended lifespan); what family he is allowed to be inserted in (e.g. a player with good karma could have the option to be reinserted as a child in a high ranking family in the game); what other player characters are allowed to be his parents; what race, class or other character type he is allowed to be in the game; whether or not he is allowed to be reinserted in the game the next time he dies; his starting level in the game (i.e. a character with good karma can start at level 10); what level of karma he begins with (i.e., some portion of karma may be passed on to the reincarnated player); how many or how quickly the player may create new offspring, etc. These conditions or limitations may be determined by other character attributes in addition to karma points.

Method 116 next includes endowing the new player character with character attributes, at least in part, based on karma, at step 134. The method further includes establishing starting karma points for the new player character. Some of these points may have been from his former life. Method 116 finally includes updating a new player character database and/or other databases.

At 140, FIG. 7 illustrates another embodiment of a method for gameplay allowing reincarnation after a player character dies. In this embodiment, the method is very similar to that of FIG. 6. One difference is that an undead character is requesting reincarnation at step 142. In response, the method retrieves the undead character's karma points at step 144, and determines whether the undead character qualifies for reincarnation at step 146. Since the undead character has likely accumulated more karma points since death, if he was previously ineligible for reincarnation, circumstances may have changed so that his increased karma point total may allow him to reincarnate. If it is determined that the undead character qualifies for reincarnation, method 140 follows steps 152-162 to create the new player character and endow the character with initial character attributes, including starting karma points, and the information is updated in the databases.

If the undead character does not qualify in step 146, the undead character may have another chance in that he may have established a relationship contract with player characters. At step 148, method 140 includes determining if the new relationship contract fulfills conditions. If conditions are not met, the undead character cannot reincarnate and it is indicated as such at step 150, and the method terminates.

In another embodiment, a player character without karma points who wants to play the game may have to begin with a player character of only one race of the game. For example, a player character with no karma points is permitted to start as an Orc or Tauren and earn karma points by playing the player character until that character dies. Through reincarnation, the karma points earned by the character may allow the player to create a new character that is of a different race than the first character. In another example, once the first character earns sufficient karma points and dies, the player character may choose a second character which can be in the human race rather than the Tauren race. In another embodiment, the accumulation of negative (bad) karma points would only allow the player to reincarnate as a new character only in races that are classified as evil. For example, a new player character established by a player whose previous player character had bad karma could only be selected from the Orc, Tauren, or undead races.

In another embodiment, only certain classes are available to a new player character based on his karma points. For instance, a new player character with no karma points could only be inserted into the game as a beggar or slave. Once he has earned enough karma points with that player character and dies, the new character of the player can have more class choices available to him. For example, the new player character could be a warrior, slave, beggar, or paladin because of the karma points he earned in a previous life in the game.

In another embodiment, reincarnation allows the player character to enter at a higher level, or as a different class. For example, the number of times a player character has been reincarnated may affect the starting level and available class choices for that character. This may or may not be further regulated based upon the amount of positive or negative karma accumulated by the player character in previous lives.

In another embodiment, the player character has a number of gameplay options. Upon death, he may choose to die and have all character attributes disposed of. In addition, he may seek to be become an undead character, possess another player character, reincarnate, and/or retain his karma points.

The invention is described with reference to multiple embodiments. However, the invention is not limited to the embodiments disclosed, and those of ordinary skill in the art will recognize that the invention is readily applicable to many other diverse embodiments and applications. Accordingly, the subject matter of the present disclosure includes all novel and nonobvious combinations and subcombinations of the various systems, methods and configurations, and other features, functions, and/or properties disclosed herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may be connected to the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Of course, it will be appreciated that the systems and methods described herein are provided for the purposes of example only and that none of the above systems methods should be interpreted as necessarily requiring any of the disclosed components or steps nor should they be interpreted as necessarily excluding any additional components or steps.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders, and may be included in modules different from what was described. In other words, any sequence or order of steps that may be explicitly described does not necessarily indicate a requirement that the steps be performed in that order. On the contrary, the steps of processes described herein may be performed in any order practical. To illustrate as an example, the step of notification to inheritors may occur multiple times due to notifications given to apprise the inheritor of status in the inheritance process. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required. For example, the step of notification to inheritors is not necessary in a situation where there are no inheritors available. In another example, if tax collection is not utilized or implemented in the virtual environment, tax-related steps are not applicable and should not be considered part of the method or program.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method of providing gameplay in a virtual environment comprising:
providing a player with an ability to play a player character with character attributes; and
upon death of the player character, providing the player with an ability to play an undead player character with limited character attributes, the limited character attributes including a subset of the character attributes of the player character;
wherein the limited character attributes include karma.

2. The method of claim 1 wherein the undead player character includes a ghost.

3. The method of claim 1 wherein karma is accumulated using karma points.

4. The method of claim 3 wherein karma points include positive karma points.

5. The method of claim 3 wherein karma points include negative karma points.

6. The method of claim 1 wherein the ability to play the undead player character includes possession of another player character.

7. The method of claim 1 wherein as an undead player character, the player can communicate with other player characters.

8. The method of claim 1 wherein the undead player character reincarnates as a new player character.

9. A method of providing gameplay in a virtual environment comprising:
reviewing at least one character attribute of the deceased player character;
determining if a deceased player character qualifies for reincarnation; and
if the deceased player character qualifies for reincarnation, creating a new player character from the deceased player character.

10. The method of claim 9 wherein said at least one character attribute includes karma.

11. The method of claim 9 wherein if the player character does not qualify for reincarnation, further comprising determining if the player character qualifies to be an undead player character.

12. The method of claim 9 wherein determining if the player character qualifies for reincarnation includes determining whether the deceased player character accumulated a sufficient number of character attributes.

13. The method of claim 12 wherein character attributes includes karma points.

14. The method of claim 9 further comprising determining if a relationship contract fulfills conditions.

15. The method of claim 9 further comprising determining initial character attributes of the new player character based on said at least one character attribute of the deceased player character.

16. The method of claim 15 wherein said at least one character attribute includes karma points.

17. The method of claim 9 further comprising establishing starting karma points of the new player character.

18. A method of providing gameplay in a virtual environment comprising:
receiving an indication that a player character desires to possess a selected player character;
determining whether to allow the player character to possess the selected player character, wherein determining is, at least in part, based on at least one character attribute of the player character;
allowing the player character possession of the selected player character; and
determining a length of time that possession is allowed.

19. The method of claim 18 wherein determining length of time is, at least in part, based on said at least one character attribute.

20. The method of claim 18 wherein said at least one character attribute includes karma points.
